(19) United States
(12) Patent Application Publication
(10) Pub. No.: US 2014/0170593 A1
(43) Pub. Date: Jun. 19, 2014

(54) PATCH FOR NON-INVASIVE PAIN RELIEF

(71) Applicant: OLTUSE, LLC, Provo, UT (US)

(72) Inventors: D. Olin Beck, Provo, UT (US); Daniel T. Garner, Blufdale, UT (US); Jeffery V. Gubler, Springville, UT (US); Dennis J. Blume, Springville, UT (US)

(73) Assignee: Oltuse, LLC, Provo, UT (US)

(21) Appl. No.: 13/718,310

(22) Filed: Dec. 18, 2012

(51) Int. Cl. A61C 19/08

(52) U.S. Cl. CPC A61C 19/08
USPC 433/80; 433/217.1; 427/2.14

(57) ABSTRACT

Adhesive patches for non-invasive pain relief comprising a molded backing layer including first and second well portions. An adhesive composition (e.g., chitosan derived) is disposed within the first well composition, and a skin penetrating anesthetic composition is disposed within the second well portion. The first well portion surrounds the perimeter of the second well portion, creating a barrier to prevent or minimize migration of the anesthetic composition outside the perimeter of the second well portion, targeting delivery to the desired site. The skin penetrating anesthetic composition includes a skin penetrating carrier (e.g., DMSO with small fractions of water and ethanol), a primary adhesive component (e.g., hydroxypropyl cellulose) to render the anesthetic composition sticky to the person's tissue, and at least one anesthetic component (e.g., -caine based components). Where two anesthetic components are included, one may act more rapidly to anesthetize pain than the first anesthetic component.

### BACKGROUND OF THE INVENTION

1. The Field of the Invention

The present invention relates generally to adhesive patches for delivery of anesthetic compositions.

2. Background and Relevant Art

Local anesthetics are drugs that provoke a reduction in sensibility and/or motor function in the area of application to the body by blocking nerve conduction, without causing the person to lose consciousness. Ideally, a local anesthetic should neither provoke irritation nor damage nerve or other tissues. In addition, it is important that the action of the local anesthetic remain limited to the area of application, so as to avoid anesthetizing other areas or causing undesirable systemic effects. Furthermore, it is important that the anesthetic action be of a duration suited to the pain stimulus (e.g. at least equal and preferably only slightly longer than the time of a surgical intervention).

While various products are available for providing local anesthesia, there exists a continuing need for improved compositions and delivery mechanisms, particularly for products that might provide desired local anesthesia, without the need for delivery of the anesthetic by needle or other invasive mechanism. It would be particularly beneficial if such a product could deliver anesthesia to a location well below the skin surface in a rapid manner, e.g., for pain blocking in anticipation of dental surgery, lancing surgery, soft tissue surgery or for relief of pain due to herniated discs, tooth aches, burns, or other causes. In some instances, such a product could replace needle delivery of local anesthetic to a location well below the skin surface (e.g., in root canal or other dental surgery) where it may be necessary to block nerves that may be 3-4 mm, or even 8-10 mm below the skin surface.

### BRIEF SUMMARY

The present invention is directed to adhesive patches for non-invasive pain relief. The patches may be employed for relief of existing pain, or placed in anticipation of prospective pain (e.g., placed in anticipation of a root canal or other dental surgery). The patch may eliminate any need for needle based delivery of anesthetic for a given procedure. In other words, use of the patch may take the place of delivering anesthetic by needle. In other embodiments, the patch may be used to provide an initial delivery of anesthetic to a location below the skin, which may be followed by needle delivery of additional anesthetic at a later time, once the tissue through which the needle is to pass has been anesthetized. The patch may be capable of delivering anesthetic to a depth at least equal to penetration of the needle that follows.

In an embodiment, an adhesive patch may include a backing layer defining a well including first and second well portions. Each well portion may be configured to receive a different composition. An adhesive composition (e.g., chitosan based) may be disposed within the first well portion, while a skin penetrating anesthetic composition may be disposed within the second well portion. The adhesive composition within the first well portion may surround the perimeter of the second well portion and its skin penetrating composition. The skin penetrating anesthetic composition may include a skin penetrating carrier that comprises a mixture of dimethylsulfoxide (“DMSO”), ethanol, and water. The anesthetic composition may also include a primary adhesive component, and one or more anesthetic components (e.g., mepivacaine, articaine, or both).

Because the adhesive composition surrounds the perimeter of the anesthetic composition, it prevents migration of the anesthetic composition from the second well into the first well (and vice versa), and prevents undesirable leakage of the anesthetic composition beyond the bounds of the second well. During use, it “targets” delivery of the anesthetic composition to tissue directly adjacent (i.e., below) the adhered patch, substantially preventing or at least minimizing any tendency for the anesthetic to spread or diffuse into tissue directly below the adhesive composition, which acts as a barrier to such diffusion prior to skin penetration. Thus, this geometric configuration aids in directing the anesthetic down and through the skin, rather than laterally outward across the skin. This delivers the anesthetic to a location deep below the skin surface, with the aid of the skin penetrating carrier, and with a minimum of unwanted lateral diffusion.

Another embodiment of an adhesive patch may include a backing layer defining first and second well portions. An adhesive composition (e.g., chitosan based) may be disposed within the first well portion, while a skin penetrating anesthetic composition may be disposed within the second well portion. The adhesive composition within the first well portion may surround the perimeter of the second well portion and its skin penetrating composition. The skin penetrating anesthetic composition may include a skin penetrating carrier (e.g., DMSO), a primary adhesive component, and first and second anesthetic components. The first and second anesthetic components may provide differing characteristics as to the rapidity at which they are capable of anesthetizing pain in a patient. For example, the second anesthetic component (e.g., mepivacaine) may act more rapidly to anesthetize pain than the first anesthetic component (e.g., articaine).

Another embodiment is directed to an adhesive patch comprising a backing layer comprising an anionic polymer defining a well including first and second well portions, an adhesive composition comprising cationic cross-linked protonated chitosan disposed within the first well portion, and a skin penetrating anesthetic composition disposed within the second well portion. The adhesive composition surrounds the perimeter of the skin penetrating anesthetic composition. The skin penetrating anesthetic composition may comprise a skin penetrating carrier comprising a mixture of DMSO, water, and ethanol, a primary adhesive component that exhibits a molecular attractive interaction with the skin penetrating carrier, and one or more anesthetic components as described above.

A related method of manufacture may include preparing an adhesive composition comprising cationic cross-linked protonated chitosan by mixing chitosan with an acid (e.g., acetic acid) and heating the protonated chitosan to cross-link the chitosan. The flowable cationic cross-linked protonated chitosan may be poured or otherwise introduced into a first well of a backing layer. The cationic cross-linked protonated chitosan within the first well may be further heated to solidify it so as to form an adhesive composition. A skin penetrating anesthetic composition may be prepared by mixing first and second anesthetic components as described above, mixing DMSO with the anesthetic components, mixing ethanol with water in approximately equivalent volume proportions to form an azeotrope ethanol/water mixture, mixing the azeotrope ethanol/water mixture with the mixture of anesthetic components and DMSO, and mixing hydroxypropyl cellulose with the resulting mixture to form a sticky flowable anesthetic composition. The flowable anesthetic composition may be poured or otherwise introduced into a second well of the backing layer prior to the anesthetic composition thickening to a highly viscous, nearly solid state. The geometry of the first and second wells is such so that the second well (and thus the anesthetic composition) has a perimeter that is surrounded by the first well. Once in place, the initially flowable anesthetic composition may continue to thicken over time, reaching a highly viscous, nearly solid state.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary adhesive patch;

FIG. 1B is an alternative perspective view of the adhesive patch of FIG. 1, better showing the “bottom” skin contacting and adhering surfaces of the patch;

FIG. 1C is a cross-sectional view through the adhesive patch of FIG. 1;

FIG. 2 shows a peelable protective layer being removed from the “bottom” skin contacting and adhering surfaces of the patch in anticipation of use;

FIG. 3 shows placement of the patch against the person's tissue, the adhesive composition adhering to adjacent skin while the recessed anesthetic composition does not yet contact the skin; and

FIG. 4 shows the patch of FIG. 3 once the patch has been pressed into place, forcing contact between the anesthetic composition and adjacent skin only after contact has been made between the adhesive composition and adjacent skin.

### DETAILED DESCRIPTION OF THE PREFERRED EMBODIMENTS

### I. Introduction

The present invention is directed to adhesive patches for non-invasive pain relief. The patches may be employed for relief of existing pain, or placed in anticipation of prospective pain (e.g., placed in anticipation of a root canal or other dental surgery). The patch may eliminate any need for needle based delivery of anesthetic for a given procedure. In other words, use of the patch may take the place of delivering anesthetic by needle. In other embodiments, the patch may be used to provide an initial delivery of anesthetic to a location below the skin, which may be followed by needle delivery of additional anesthetic at a later time, once the tissue through which the needle is to pass has been anesthetized. The patch may be capable of delivering anesthetic to a depth at least equal to penetration of the needle that follows. Such patches may also be employed for myriad other pain relief uses, such as burn pain relief, tooth aches, lancing or other surgeries, herniated disc pain relief, etc.

In one embodiment, the adhesive patch includes a backing layer defining first and second well portions. The perimeter of the second well portion is surrounded by the first well portion (e.g., the well portions are concentric to one another). An adhesive composition (e.g., chitosan based) is disposed within the first well portion, and a skin penetrating anesthetic composition is disposed within the second well portion, so as have a perimeter surrounded by the adhesive composition. The skin penetrating anesthetic composition includes a skin penetrating carrier (e.g., DMSO), a primary adhesive component, and at least one anesthetic component.

### II. Exemplary Patches for Pain Relief

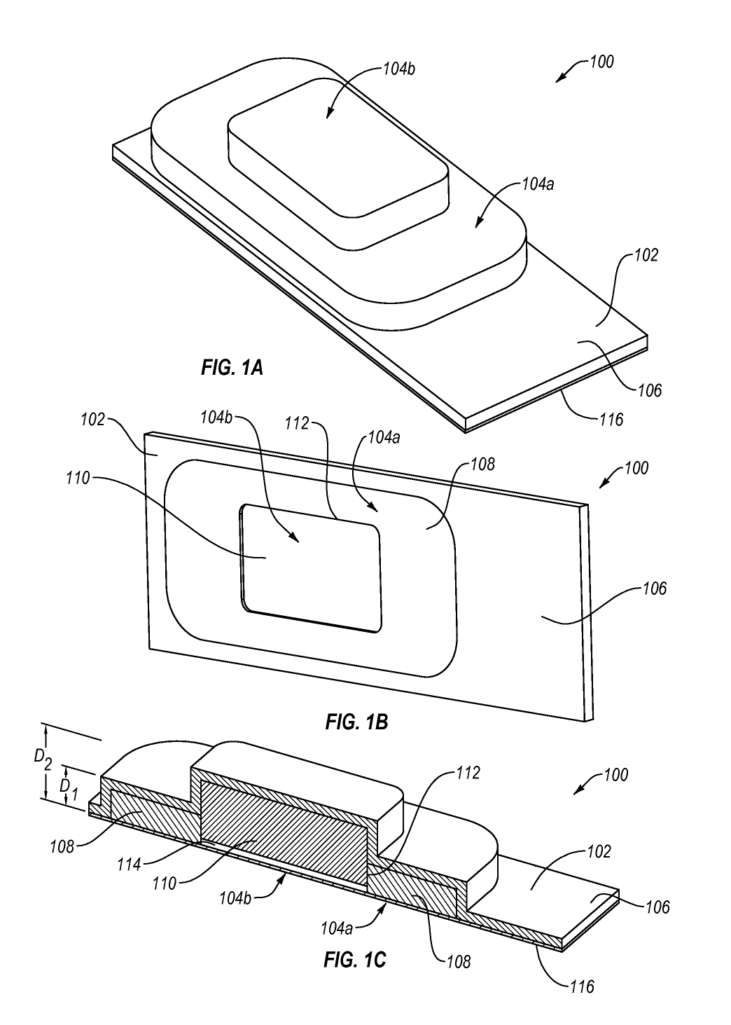

FIGS. 1A through 1C shows an exemplary patch 100 including backing layer 102 defining a first well portion 104a and a second well portion 104b. Backing layer 102 may be a molded three dimensional elongate structure (e.g., vacuformed, thermoformed, or otherwise formed). At one elongate end, backing layer 102 may include a tab portion 106 that may be helpful in handling, gripping, and placing patch 100. Tab portion may be substantially two dimensional, so as to not include any well portion defined by a depth. As such, a person may grasp tab 106 without contacting either adhesive composition 108 or anesthetic composition 110. In one embodiment, tab 106 may have a length of about 4 mm to about 10 mm to provide sufficient area to be easily gripped between person's finger and thumb.

First well portion 104a may completely surround a perimeter 112 of second well portion 104b. In addition, first well portion 104a may have a sufficient width so that a surface area of an adhesive composition 108 disposed within first well portion 104a may provide an effective barrier against diffusion of anesthetic composition 110 through adhesive composition 108. For example, first well portion and adhesive composition 108 may have a width on each side of skin penetrating anesthetic composition 110 that is at least about 25%, at least about 35%, or at least about 50%, of the width of skin penetrating anesthetic composition 110. Such a geometric configuration aids in providing an effective barrier against unwanted diffusion of skin penetrating composition 110 beyond the rough confines defined by the perimeter 112 of skin penetrating anesthetic composition 110.

As seen in FIG. 1C, the depth D₁ defined by first well 104a may be significantly less than the depth D₂ defined by second well 104b. For example, second well 104b may have a depth that is at least about 125% that of first well 104a, at least about 150% of first well 104a, or at least about twice that of first well 104a.

As perhaps best seen in FIG. 1C, each of well portions 104a and 104b may be substantially filled by their respective compositions 108, 110, respectively, although second well portion 104b may be filled with skin penetrating anesthetic composition 110 to a level that is slightly recessed below the level of adjacent adhesive composition 108. Recess 114 may aid in ensuring contact with a person's skin occurs first with more prominent adhesive composition 108, rather than with recessed skin penetrating anesthetic composition 110.

Backing layer 102 may comprise a polymeric plastic material. In one embodiment, backing layer may comprise an anionic polymer, so as to provide a desired adhesion effect relative to adhesive composition 108 (e.g., which may comprise a cationic adhesive material). An alternative embodiment may employ a cationic polymer paired with an anionic adhesive material, so as to provide a desired charge-based adhesion characteristic between backing layer 102 and adhesive composition 108. Backing layer 102 may be formed of a material that is sufficiently flexible to allow a user to press it down, adhering patch 100 to a user's skin. Such flexibility may aid in pressing anesthetic composition 110 into contact with the skin as shown in FIG. 4, effectively removing recess 114. Flexibility also aids patch 100 in confirming to the contours of the user's tissue once placed, while remaining adhered in place. While being flexible as described, backing layer 102 preferably has sufficient rigidity to maintain recess 114 (i.e., preventing sagging of second well portion 104b and composition 110, that would otherwise close gap 114) prior to pressing the back side of central well 104b, contacting anesthetic composition 110 to the skin.

In one embodiment, backing layer 102 comprises polyethylene terephalate (“PET”). Polyethylene terephalate is an anionic polymer, which strongly adheres to the cationic chitosan derived adhesive composition. The inventors have found that at least some commonly employed polyolefins may not be suitable for use, at least with the cationic chitosan derived adhesive composition, as they do not provide the desired strong adhesion between the backing layer and the adhesive composition. For example, polyethylene may not be suitable for use in at least some embodiments, as it will not adhere to the cationic chitosan derivative. Nitrile based materials may also not be suitable for use, as they may be dissolved by DMSO. Those of skill in the art will recognize suitable backing materials in light of the present disclosure. Cellulose acetate may be another suitable material, as may paper (although it may not be impervious to DMSO).

To provide the desired balance of rigidity and flexibility, the backing layer may have a thickness of about 7 mils (0.007 inch)±about 5 mils (0.005 inch) depending on how it is to be used.

A. Adhesive Composition

Adhesive composition 108 within first well portion 104a may comprise a chitosan derived adhesive material. Adhesive composition 108 provides excellent adhesion to a person's tissue (e.g., skin) surrounding the location to which the anesthetic is to be delivered. Adhesive composition 108 may comprise a cationic adhesive material, such as a chitosan derivative. In one embodiment, the chitosan may be of “medium” molecular weight. For example, it may have a molecular weight of at least about 100,000 Daltons, at least about 250,000 Daltons, or at least about 400,000 Daltons. Molecular weight may be from about 100,000 Daltons to about 2,000,000 Daltons, from about 250,000 Daltons to about 1,000,000 Daltons, or from about 400,000 Daltons to about 550,000 Daltons.

In an embodiment, the adhesive composition may comprise cationic cross-linked protonated chitosan, which may be prepared by mixing chitosan with an acid. In one embodiment, an organic acid, such as acetic acid is employed. Mixing chitosan with acid protonates the chitosan. In an embodiment, an aqueous solution of acetic acid may include from about 1% to about 50% acetic acid (or equivalent), from about 2% to about 10% acetic acid (or equivalent), or from about 4% to about 6% acetic acid (or equivalent). In an embodiment, the degree of protonation of the chitosan may be from about 1% to about 25%, from about 2% to about 10%, or from about 4% to about 8%. Once the chitosan has been protonated, it may be cross-linked by heating the protonated chitosan.

Once cross-linked, the cationic cross-linked protonated chitosan may have a flowable consistency. The flowable adhesive composition may be poured or otherwise introduced into first well portion 104a of backing layer 102, with a void “block” or other barrier temporarily occupying second well portion 104b so as to prevent flowable adhesive composition 108 from flowing into second well portion 104b. Such a void block or barrier may be solid or hollow (e.g., a hollow barrier about perimeter 112). Flowable adhesive composition 108 within first well portion 104a may be heated (e.g., placed within an oven) to further dehydrate adhesive composition 108, solidifying it onto backing layer 102. Once adhesive composition 108 is sufficiently thickened or solidified, the void block or other barrier temporarily placed within second well portion 104b may be removed. In another embodiment, second well portion 104b may be filled prior to first well portion 104a. A barrier or void block may similarly be placed to retain anesthetic composition 110 within second well portion 104b, preventing it from migrating into first well portion 104a while in a flowable state.

B. Skin Penetrating Anesthetic Composition

Skin penetrating anesthetic composition 110 is disposed within second well portion 104b, surrounded by adhesive composition 108. Skin penetrating anesthetic composition 110 is particularly formulated to provide the ability to deliver one or more anesthetic components below the protective epidermal skin layers of a person. The epidermal skin layers are specifically configured to normally prevent penetration of external materials outside the skin from penetrating through the epidermal skin layers and into the body. For example, typical epidermal skin layers may include, from the exterior towards the interior, a statum corneum layer. a stratum lucidum layer, a stratum granulosum layer, a stratum spinosum layer, and a stratum basale layer that overlies vascularized tissue, including blood vessels and nerves. The various layers prevent most materials that might contact a person's exterior skin layers from penetrating through, to the interior of the body. As such, specially formulated compositions are required where it is desired to cause a material to be carried through the protective skin layers. In the present case, it is desired to carry one or more anesthetic components to a location that may be well below the protective skin layers. By way of example, the typical epidermal skin layers may typically have a thickness from about 0.5 mm to about 2 mm. Where relieving pain associated with a root canal, other dental surgery, or similar situation where pain is well below the epidermal skin layers (e.g., a herniated disc), it may be necessary to deliver anesthetic to a location that may be 3-4 mm below the skin surface, 8-10 mm below the skin surface (e.g., roots of the lower mandibular teeth may extend this deep), or even deeper. Merely placing a topical anesthetic onto the skin surface will not be effective in delivering the anesthetic to the desired location, well below the skin surface. As such, a skin penetrating carrier is employed to carry the anesthetic(s) to the desired depth.

(i) Skin Penetrating Carrier

The anesthetic composition 110 includes a skin penetrating carrier capable of carrying the anesthetic component(s) through the protective skin layers, down to nerves where the pain is to be blocked. In one embodiment, the skin penetrating carrier comprises dimethylsulfoxide (“DMSO”). For example, at least about 75%, at least about 85%, or from about 85% to about 95% (e.g., about 90%) of the skin penetrating carrier by volume may comprise DMSO. Stated another way, at least about 25%, at least about 30%, or from about 30% to about 40% (e.g., about 35%) of the skin penetrating anesthetic composition may comprise DMSO. About 50% of the skin penetrating anesthetic composition may comprise the one or more anesthetic component(s), so that next to the anesthetic components, the skin penetrating carrier is the next major component by weight fraction.

The inventor has found that including small fractions of ethanol and water with the DMSO actually provides better skin penetrating ability than DMSO alone. That the inclusion of water would increase the penetrating effectiveness of DMSO is surprising, as water alone is ineffective as a skin penetrating constituent. In addition, although ethanol alone may have some skin penetrating ability, it is less effective than DMSO alone. Thus, DMSO alone is more effective than ethanol, which is more effective than water. As such, it is surprising that the addition of ethanol and water to DMSO actually enhances the skin penetrating ability of the resulting skin penetrating carrier comprising DMSO with small fractions of ethanol and water.

As such, in one embodiment, the skin penetrating carrier may comprise about 1% to about 10% ethanol by volume, from about 2% to about 8% ethanol by volume, or from about 4% to about 6% (e.g., 5%) ethanol by volume. Similarly, the skin penetrating carrier may comprise about 1% to about 10% water by volume, from about 2% to about 8% water by volume, or from about 4% to about 6% (e.g., 5%) water by volume. Stated another way, ethanol and/or water may each be included in a range of about 0.5% to about 5%, about 0.75% to about 3%, or about 1% to about 2% by weight of the skin penetrating anesthetic composition.

In one embodiment, the water and ethanol may be present in substantially equal volume fractions, providing an azeotrope ethanol/water mixture. Because the water and ethanol are present as an azeotrope mixture, they remain in the azeotrope concentrations, even upon evaporation of a portion of the composition. This helps to ensure that the desired concentration ratios of the DMSO, ethanol, and water are maintained, even if the composition is dried or otherwise experiences evaporation during manufacture, storage, etc.

Enhancement of the skin penetrating ability over what might be provided by a skin penetrating carrier consisting of DMSO alone is particularly beneficial because such high weight fractions of anesthetic component are typically included within the composition. For example, if the skin penetrating carrier comprises 38% of the anesthetic composition by weight, inclusion of small fractions of water and ethanol in addition to DMSO (e.g., about 1.5% each and 3% total) provides better penetrating ability than where the entire 38% consists of DMSO. This is helpful, as while very large fraction of DMSO may be entirely capable of penetrating through the skin layers (e.g., 50%, 60%, 70%, 80%), this is not feasible where about 50% of the anesthetic composition is the anesthetic itself. Thus, in one embodiment, the DMSO comprises no more than about 45% of the anesthetic composition, or no more than about 40% of the anesthetic composition.

In one embodiment, the skin penetrating carrier consists of DMSO, ethanol, and water (e.g., 90% DMSO, 5% ethanol, and 5% water).

In addition to or alternative to DMSO, other constituents capable of penetrating through the skin layers, and carrying the anesthetic component(s) therethrough may alternatively or also be employed. Examples of such other skin penetrating constituents may include azone, oleic acid, propylene glycol, ethanol, isopropyl alcohol, and combinations thereof. In some embodiments, one or more such components may be employed in combination with DMSO as a skin penetrating carrier.

(ii) Primary Adhesive Component

In addition to adhesion to the user's tissue as provided by adhesive composition 108, skin penetrating anesthetic composition 110 also includes an adhesion component. Because anesthetic composition 110 provides the anesthetic component to the desired target location, the adhesion component included within anesthetic composition 110 may be referred to herein as a primary adhesive component, as it provides primary adhesion of “active” composition 110 and patch 100 to the skin or other exposed tissue of the user. The primary adhesive component included within composition 110 may be different than the adhesive component(s) included within adhesive composition 108.

For example, while adhesive composition 108 may be derived from chitosan, the primary adhesive component of skin penetrating anesthetic composition 110 may comprise a cellulosic material that exhibits a molecular attractive interaction with the DMSO or other skin penetrating carrier. In an embodiment, the primary adhesive component comprises hydroxypropyl cellulose, which has been observed by the inventor to exhibit an attractive interaction with DMSO. This characteristic may be an electrostatic interaction due to the polarity characteristics of DMSO and hydroxypropyl cellulose. This interaction is not believed to be due to hydrogen bonding.

In evaluating other cellulose derived prospective adhesive components, it has been found that carboxymethyl cellulose (including —OCH₂CO₂H groups) does not exhibit the desired attractive interaction, and thus may not be suitable for use as the primary adhesive component, at least in combination with a DMSO skin penetrating carrier. In addition to hydroxypropyl cellulose, hydroxypropyl methyl cellulose may be suitable for use as a primary adhesive component, based on the chemical structure similarity. In hydroxypropyl methyl cellulose, at least some of the hydroxyl groups in the repeating glucose units may include methoxy groups (—OCH₃), rather than hydroxypropyl groups (—OCH₂CH(OH)CH₃). Combinations of various adhesive components, including hydroxypropyl cellulose and/or hydroxypropyl methyl cellulose may be suitable for use.

The chemical structures of carboxymethyl cellulose, hydroxypropyl cellulose, and hydroxypropyl methyl cellulose are shown below. Each includes the same cellulose backbone, with differences in the substitution groups attached to the repeating glucose units of the cellulose backbone. Hydroxypropyl cellulose includes at least some hydroxypropyl groups (—OCH₂CH(OH)CH₃). Hydroxypropyl methyl cellulose may include hydroxypropyl groups (—OCH₂CH(OH)CH₃) and/or methyl groups (—OCH₃). Carboxymethyl cellulose includes at least some carboxymethyl groups (OCH₂CO₂H). Thus, in an embodiment, the primary adhesive component may be a cellulose derived material comprising at least some hydroxypropyl groups (—OCH₂CH(OH)CH₃). In addition to hydroxypropyl groups, some positions may be substituted with methoxy groups (—OCH₃).

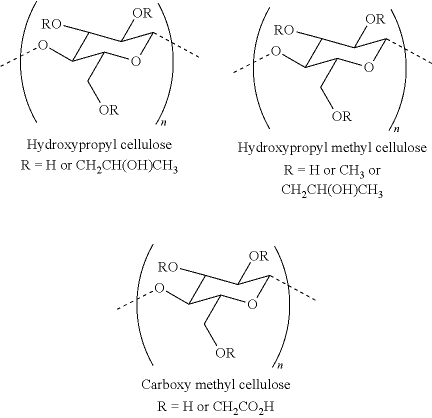

(iii) Anesthetic Components

Skin penetrating anesthetic composition 110 includes one or more local anesthetic components. The local anesthetic component(s) may be -caine based anesthetics, such as mepivacaine, articaine, procaine, amethocaine, cocaine, lidocaine, prilocaine, bupivicaine, levobupivacaine, ropivacaine, dibucaine, or combinations thereof. Salts of the various local anesthetics may also be employed (e.g., HCl salts of any of the above -caines). The ester based anesthetics (e.g., procaine, amethocaine, and cocaine) may be less preferred relative to the amide based anesthetics (e.g., mepivacaine, articaine, lidocaine, prilocaine, bupivicaine, levobupivacaine, ropivacaine, and dibucaine) due to their generally better stability and lower incidence of side effects.

In one embodiment, skin penetrating anesthetic composition 110 may include two different anesthetic components, in which one anesthetic component acts more rapidly to anesthetize pain in a patient during use than at least one other included anesthetic component. For example, skin penetrating anesthetic composition 110 may include mepivacaine and articaine. Mepivacaine acts more quickly than articaine.

The one or more local anesthetic components may collectively comprise from about 25% to about 75%, from about 35% to about 65%, or from about 45% to about 55% (e.g., about 50%) by weight of the skin penetrating anesthetic composition. Where two or more local anesthetic components are provided (e.g., mepivacaine and articaine), they may be included in equal weight fractions. For example, the faster acting local anesthetic (e.g., mepivacaine) may comprise from about 10% to about 40%, from about 15% to about 35%, or from about 20% to about 30% (e.g., 25%) by weight of the skin penetrating anesthetic composition. The slower acting local anesthetic (e.g., articaine) may also comprise from about 10% to about 40%, from about 15% to about 35%, or from about 20% to about 30% (e.g., 25%) by weight of the skin penetrating anesthetic composition.

In an embodiment, epinephrine or another vasoconstrictor may be included within the skin penetrating anesthetic composition in order to extend the duration of the anesthetic effect provided by the one or more local anesthetics. For example, epinephrine may be included in the skin penetrating anesthetic composition in a range from about 0.5 ppm to about 50 ppm, from about 1 ppm to about 20 ppm, or from about 5 ppm to about 10 ppm.

Skin penetrating anesthetic composition 110 may be formed by mixing together the anesthetic components (where two or more are included). The DMSO skin penetrating carrier component is added to the anesthetic component(s). Ethanol and water are mixed together in equal volume proportions to form an azeotrope mixture to prevent ethanol from preferentially evaporating out from the final composition. The ethanol/water azeotrope mixture is added to the anesthetic/DMSO mixture. The mixture may then be emulsified. The hydroxypropyl cellulose may be added to the emulsified mixture to form a sticky paste-like, but flowable composition. The resulting composition is mixed until substantially homogenous. The completed skin penetrating anesthetic composition may then be poured or otherwise introduced into backing layer 102 (e.g., into well portion 104b) previously occupied by the void block or other barrier employed to maintain adhesive composition 108 within first well portion 104a.

Once compositions 108 and 110 are in place, patch 100 may be sealed to prevent evaporation and/or degradation to the components. Sealing may be provided by a peelable protective sealing layer 116, as seen in FIGS. 1A and 1C. Sealing layer 116 may be impermeable to water, oxygen, and/or air, as desired.

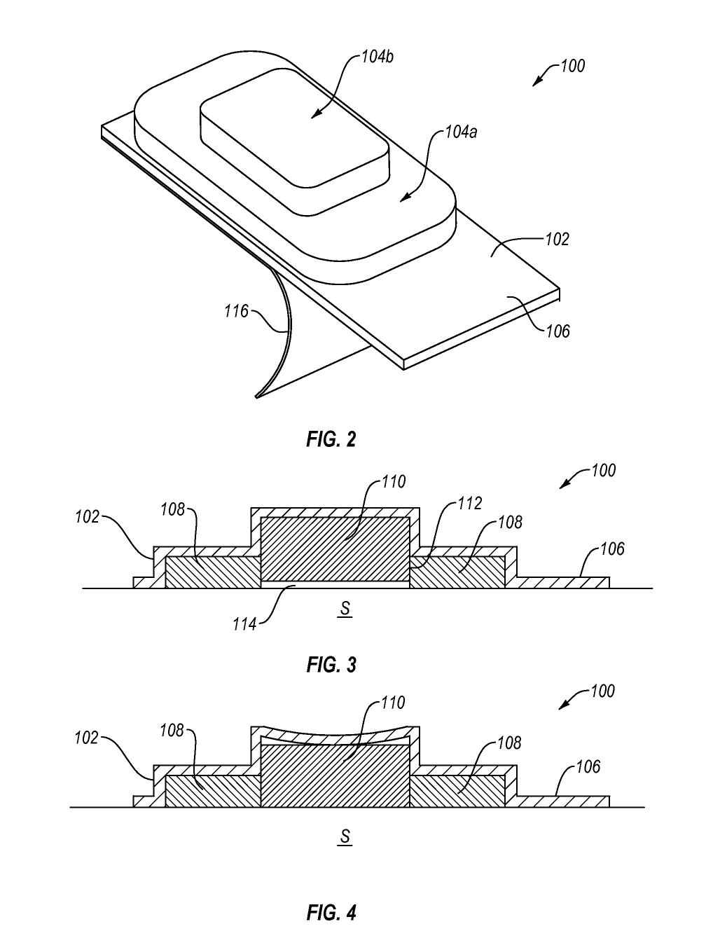

FIGS. 2-4 show placement and use of an exemplary patch 100. As seen in FIG. 2, protective sealing layer 116 may be removed immediately prior to use, and positioned (FIG. 3) adjacent skin layer or other target location S into which the anesthetic component(s) are to be delivered. As shown in FIG. 3, upon initial placement, adhesion of patch 100 to skin S may be provided by adhesive composition 108. As seen in FIG. 3, a gap 114 may initially be present between anesthetic composition 110 and skin S. As seen in FIG. 4, once initial adhesion is provided between skin S and patch 100 by adhesive composition 108, the exposed backside of second well portion 104b of backing layer 102 may be pressed, pushing skin penetrating anesthetic composition 110 into adhesive contact with skin S.

### III. Examples

Adhesive patches as shown in FIGS. 1A-1C were manufactured and tested for their effectiveness in blocking pain associated with dental surgeries. The employed backing layer was formed of polyethylene terephalate (“PET”), and had a thickness of about 5 mils (i.e., 0.005 inch). The adhesive composition was prepared with a chitosan derivative. Medium molecular weight (about 480,000 Daltons) chitosan, 75-85% deacetylated, was cross-linked using heat. The chitosan was first mixed with a solution of 5% acetic acid to give between 4% and 12% protonation of the chitosan. This solution was then heated to cross-link the chitosan. Once the solution reached high viscosity, it was poured into the first well portion of the backing layer mold with a void “block” occupying the central well portion into which the skin penetrating anesthetic composition was later introduced. The backing layer mold containing the adhesive composition within the first well portion was then placed under 100° F. heat to further dehydrate the chitosan and solidify it onto the backing layer. The cationic cross-linked protonated chitosan strongly adhered to the anionic PET backing layer, so that removal of the chitosan derived adhesive composition from the PET backing layer could not readily be achieved without distortion or damage to the PET backing layer. The bonding force between the PET and adhesive composition is at least sufficient to support the weight of the adhesive composition so that when one flips the patch upside down the adhesive composition adheres to the backing layer rather than separating or peeling away under its own weight.

The skin penetrating anesthetic composition was prepared by mixing mepivacaine HCl and articaine HCl in equal weight quantities. DMSO was added to the mixture. Pure ethanol was mixed with water in equivalent volume proportions to azeotrope the ethanol so that it would not preferentially evaporate from the final mixture. The ethanol/water mixture was then added to the anesthetic/DMSO mixture. The resulting mixture was then emulsified. Finally, hydroxypropyl cellulose was added to the mixture to form a sticky paste. The sticky paste was mixed until homogenous. The weight fractions of the various components of the skin penetrating anesthetic composition were as follows:

| Component | Weight Percent |
|---|---|
| Mepivicaine | 25% |
| Articaine | 25% |
| DMSO | 35% |
| Water | 1.6% |
| Ethanol | 1.4% |
| Hydroxypropyl Cellulose | 12% |

The weight fractions of the dry ingredients were as follows:

| Component | Weight Percent |
|---|---|
| Mepivicaine | 40% |
| Articaine | 40% |
| Hydroxypropyl Cellulose | 20% |

The volume fractions of the liquid ingredients (i.e., the skin penetrating carrier) were as follows:

| Component | Weight Percent |
|---|---|
| DMSO | 90% |
| Water | 5% |
| Ethanol | 5% |

The completed formulation for the skin penetrating anesthetic composition was poured into the backing layer mold where the void “block” had previously occupied. The void space (now occupied by the skin penetrating anesthetic composition) had a volume of about 0.25 mL.

The patch can be sealed (e.g., with a peelable protective layer) to prevent or minimize evaporation. Refrigeration of the patch may also help to prolong the shelf life of the patch.

The resulting patch may be employed for superficial nerve block, but can also be applied for pain relief and local anesthesia without nerve block. A relatively high dose of the skin penetrating anesthetic composition may be employed as a local anesthesia shot replacement in dental or medical clinics. A relatively lower dose could be employed in over the counter pain relief (e.g., for burns or tooth aches). As such, the volume and skin contacting surface area of the skin penetrating anesthetic composition within the central well portion can be varied, depending on the application.

Changes in dosage may be achieved by increasing or decreasing the weight fraction of the anesthetic(s), by increasing or decreasing the fraction of hydroxypropyl cellulose or other primary adhesive, or by altering the volume or skin contacting surface area of the second well portion and anesthetic composition 110. Increased dosage may be employed to achieve relatively deeper penetration of the anesthetic(s).

In one embodiment, while slight changes in weight fractions may be possible, in one embodiment, the hydroxypropyl cellulose or other primary adhesive should not be below about 10% by weight in order to provide proper adhesion of the anesthetic composition to the tissue to which it is applied.

The PET backing layer may be vacuformed to the desired molded shape and structure. A thickness of about 5 mils is particularly well suited for placement adjacent a tooth root for dental surgery, as the balance of rigidity and flexibility provided by such a material and thickness is helpful in allowing the adhered patch to conform to the surface to which it is adhered.

As used in this specification and the appended claims, the singular forms “a,” “an” and “the” include plural referents unless the context clearly dictates otherwise.

The present invention can be embodied in other specific forms without departing from its spirit or essential characteristics. Thus, the described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An adhesive patch for non-invasive pain relief comprising:
a backing layer defining a well including first and second well portions;
an adhesive composition disposed within the first well portion; and
a skin penetrating anesthetic composition disposed within the second well portion, the adhesive composition surrounding a perimeter of the anesthetic composition, the anesthetic composition comprising:
a skin penetrating carrier comprising a mixture of DMSO, water, and ethanol;
a primary adhesive component; and
at least one anesthetic component.

2. The patch as recited in claim 1, wherein the skin penetrating carrier comprises about 90% DMSO by volume, about 5% water by volume, and about 5% ethanol by volume.

3. The patch as recited in claim 1, wherein the primary adhesive component comprises at least one of hydroxypropylcellulose or hydroxylpropyl methyl cellulose.

4. The patch as recited in claim 1, wherein both the first and second anesthetic components are -caine based.

5. The patch as recited in claim 1, wherein the skin penetrating anesthetic composition further comprises epinephrine.

6. The patch as recited in claim 1, wherein the skin penetrating anesthetic composition is recessed relative to the adhesive composition so that the adhesive composition adheres to a person's tissue prior to contact of the skin penetrating anesthetic composition with the person's tissue so as to form a barrier about the perimeter of the penetrating anesthetic composition to prevent leakage.

7. The patch as recited in claim 1, wherein the adhesive composition comprises cross-linked, protonated chitosan that is cationic and the backing layer comprises an anionic polymer so that the adhesive composition strongly adheres to the backing layer.

8. The patch as recited in claim 1, wherein the anionic polymer backing layer comprises polyethylene terephalate (PET).

9. An adhesive patch for non-invasive pain relief comprising:
a backing layer defining a well including first and second well portions;
an adhesive composition (e.g., chitosan) disposed within the first well portion; and
a skin penetrating anesthetic composition disposed within the second well portion, the adhesive composition surrounding a perimeter of the anesthetic composition, the anesthetic composition comprising:
a skin penetrating carrier;
a primary adhesive component;
a first anesthetic component; and
a second anesthetic component, the second anesthetic component acting more rapidly to anesthetize pain in a patient during use than the first anesthetic component.

10. The patch as recited in claim 9, wherein the skin penetrating carrier comprises DMSO.

11. The patch as recited in claim 9, wherein the first anesthetic component comprises articaine and the second anesthetic comprises mepivicaine.

12. The patch as recited in claim 9, wherein the skin penetrating anesthetic composition comprises:

| Component | Weight Percent |
|---|---|
| Mepivicaine | about 25% |
| Articaine | about 25% |
| DMSO | about 35% |
| Water | about 1.6% |
| Ethanol | about 1.4% |
| Hydroxypropyl Cellulose | about 12% |

13. An adhesive patch for non-invasive pain relief comprising:
a backing layer comprising an anionic polymer defining a well including first and second well portions;
an adhesive composition comprising cationic cross-linked protonated chitosan disposed within the first well portion; and
a skin penetrating anesthetic composition disposed within the second well portion, the adhesive composition surrounding a perimeter of the anesthetic composition, the anesthetic composition comprising:
a skin penetrating carrier comprising a mixture of DMSO, water, and ethanol;
a primary adhesive component exhibiting a molecular attractive interaction with the skin penetrating carrier;
a first anesthetic component; and
a second anesthetic component, the second anesthetic component acting more rapidly to anesthetize pain in a patient during use than the first anesthetic component.

14. The patch as recited in claim 13, wherein the primary adhesive component comprises at least one of hydroxypropylcellulose or hydroxylpropyl methyl cellulose.

15. The patch as recited in claim 13, wherein both the first and second anesthetic components are -caine based.

16. The patch as recited in claim 13, wherein the first anesthetic component comprises articaine and the second anesthetic comprises mepivicaine.

17. The patch as recited in claim 13, wherein the skin penetrating anesthetic composition comprises:

| Component | Weight Percent |
|---|---|
| Mepivicaine | about 25% |
| Articaine | about 25% |
| DMSO | about 35% |
| Water | about 1.6% |
| Ethanol | about 1.4% |
| Hydroxypropyl Cellulose | about 12% |

18. The patch as recited in claim 13, wherein the first well portion includes substantially no anesthetic component.

19. A method of manufacturing an adhesive patch for non-invasive pain relief, the method comprising:
preparing an adhesive composition comprising cationic cross-linked protonated chitosan by mixing chitosan with an acid and heating the protonated chitosan to cross-link the chitosan;
introducing the flowable cationic cross-linked protonated chitosan into a first well portion of a backing layer and further heating the cationic cross-linked protonated chitosan to solidify it within the first well portion of the backing layer;
preparing a skin penetrating anesthetic composition by:
providing at least one anesthetic component;
mixing DMSO with the one or more anesthetic components;
mixing ethanol with water in equivalent volume proportions to form an azeotrope ethanol water mixture;
mixing the azeotrope ethanol water mixture with the mixture of anesthetic component(s) and DMSO;
mixing at least one of hydroxypropylcellulose or hydroxylpropyl methyl cellulose with the mixture of the azeotrope, anesthetic component(s), and DMSO to form a sticky flowable skin penetrating anesthetic composition; and
introducing the flowable sticky skin penetrating anesthetic composition into a second well portion of the backing layer prior to the skin penetrating anesthetic composition solidifying, the second well portion having a perimeter that is surrounded by the first well portion being.

20. The method of manufacture as recited in claim 19 wherein the skin penetrating anesthetic composition comprises:

| Component | Weight Percent |
|---|---|
| Mepivicaine | about 25% |
| Articaine | about 25% |
| DMSO | about 35% |
| Water | about 1.6% |
| Ethanol | about 1.4% |
| Hydroxypropyl Cellulose | about 12% |

21. A method of providing local anesthesia comprising providing an adhesive patch as recited in claim 1 and adhering the patch to oral tissue of a person prior to performing dental surgery.
